(19) United States
(12) Patent Application Publication
(10) Pub. No.: US 2016/0127429 A1
(43) Pub. Date: May 5, 2016

(54) APPLICANT ANALYTICS FOR A MULTIUSER SOCIAL NETWORKING SYSTEM

(71) Applicant: Linkedln Corporation, Mountain View, CA (US)

(72) Inventors: Satpreet Harcharan Singh, Chicago, IL (US); Suman Sundaresh, Los Altos, CA (US)

(21) Appl. No.: 14/581,489

(22) Filed: Dec. 23, 2014

Related U.S. Application Data
(60) Provisional application No. 62/073,712, filed on Oct. 31, 2014.

(51) Int. Cl. H04L 29/06; G06F 17/30

(52) U.S. Cl. CPC H04L 65/403; G06F 17/30867; G06F 17/30598; G06F 17/3053; G06Q 50/01

(57) ABSTRACT

A method and system for conducting applicant analytics for a multiuser social networking system is disclosed. A social networking system stores member qualification data for a plurality of members of a social networking system. The social networking system receives an education institution interest indication. The social networking system receives an analytics data request from the client system, wherein the analytics request indicates a first education institution. The social networking system determines a list of other members of the social networking system that have indicated interest in the first education institution. The social networking system generates comparison data for the first member and the determined list of other members, wherein comparison data compares member qualification data of the first member and the determined list of other members. The social networking system transmits the generated comparison data to the client system.

### RELATED APPLICATIONS

This application claims priority to U.S. Provisional Patent Application Ser. No. 62/073,712, filed Oct. 31, 2014, which is incorporated herein by reference in its entirety.

### TECHNICAL FIELD

The disclosed implementations relate generally to the field of social networks and in particular to a system for analyzing applicant data.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly. Similarly, online social networking sites allow members to build and maintain personal and business relationships in a much more comprehensive and manageable manner.

One important application of new computer technologies is allowing users to explore and learn. Some education tools are being moved such that they can be accessed directly over the Internet. For example, massive open online courses (MOOCs) allow users from different parts of the world to all experience the same education experiences. In addition, even non-network based education can be enhanced by improving access to information about schools, programs, and opportunities to interested parties. Networked computer systems can collect and process large amounts of data to streamline and enhance education opportunities.

### DESCRIPTION OF THE DRAWINGS

Some implementations are illustrated by way of example and not limitation in the figures of the accompanying drawings, in which:

FIG. 1 is a network diagram depicting a client-server system that includes various functional components of a social networking system, in accordance with some implementations.

FIG. 2 is a block diagram illustrating a client system, in accordance with some implementations.

FIG. 3 is a block diagram illustrating a social networking system, in accordance with some implementations.

FIG. 4 is a member interface diagram illustrating an example of a member interface, according to some implementations.

FIG. 5 is a flow diagram illustrating a process, in accordance with some example embodiments, for using interest and qualification data from a large pool of members to generate useful statistical data for a particular member.

FIGS. 6A and 6B are a flow diagram illustrating a process, in accordance with some example embodiments, for using interest and qualification data from a large pool of members to generate useful statistical data for a particular member.

FIG. 7 is a block diagram illustrating an architecture of software, which may be installed on any one or more of devices of a computer system.

FIG. 8 is a block diagram illustrating components of a machine, according to some example embodiments.

Like reference numerals refer to corresponding parts throughout the drawings.

### DETAILED DESCRIPTION

The present disclosure describes methods, systems and computer program products for using interest and qualification data from a large pool of members to generate useful statistical data for a particular member. In the following description, for purposes of explanation, numerous specific details are set forth to provide a thorough understanding of the various aspects of different implementations. It will be evident, however, to one skilled in the art, that any particular implementation may be practiced without all of the specific details and/or with variations, permutations, and combinations of the various features and elements described herein.

A social networking system stores data for millions of members of the social network. This data can be leveraged to assist members of the social network in researching and pursuing educational opportunities. In some example embodiments, the social networking system stores qualification data for a plurality of the members of the social network.

Qualification data includes any data that may be considered by a school when determining whether to admit a potential student. For example, qualification data includes, but is not limited to, test scores, employment history, demographic information, work history, education history, grade point averages, hobbies, accomplishments, volunteer history, and so on. In some example embodiments, the qualification data is explicitly supplied by the member (e.g., the member transmits test scores to the social networking system). In other example embodiments, the social networking system is able to infer some qualification information such as demographic information and work history. In other example embodiments, the social networking system verifies information submitted by a member or inferred by the system through testing agencies or educational institutions with the member's permission.

The social networking system receives an interest notification message from a client system associated with a first member. An interest notification message includes a list of one or more education institutions and informs the social networking system that the member is at least potentially interested in applying to those one or more education institutions. In some example embodiments, the interest notification message also includes a request for additional information about the one or more education institutions. The interest notification message includes, but is not limited to, the member identification number, one or more schools the member is interested in, a time frame the member is interested in (e.g., the school year the member intends to attend one of the schools), and any other relevant information. In some example embodiments, the interest notification message also includes a request for data analytics for one or more of the education institutions listed in the interest notification message.

In response to receiving an interest notification message, the social networking system determines a list of potential applicant members that have also indicated an interest in attending a respective education institution in the list of education institutions in the interest notification message received from the first member. The list of members is determined based on one or more interest notification messages from one or more other members of the social networking system. This list potentially represents a sample of the group of potential applicants that are applying to the respective education institution. The social networking system can then analyze the qualification data stored for each member in the list of potential applicant members that have indicated an interest in attending the respective education institution.

In some example embodiments, the social networking system organizes the qualification data into categories (e.g., SAT scores, high school GPA, college GPA, years of experience in field) and then generates a rank in each category for each member in the list of potential applicant members. Thus the social networking system can automatically determine where the first member ranks relative to other potential students in a variety of categories. In some example embodiments, the social networking system generates an overall candidate score or rank. The overall candidate score is based on rankings of each category of qualification data and differing weights attached to each category based on the category's importance. For example, an MBA program may give the category that measures the number of years of work experience in an appropriate field the highest weight while assigning high school GPA the lowest weight. In some example embodiments, the social networking system determines, for each education institution, what category scores are important and how they are weighted. In some example embodiments, this is determined from available acceptance data.

Each category of qualification data will then have a range of scores, from the member with the highest score in that category, to the member with the lowest score in that category. The members can be given a rank for each category and/or an overall rank. In some example embodiments, the social networking system then transmits the generated rankings and/or scores to the requesting client system for display. These rankings or scores can be represented in any suitable manner including charts and graphs that visually depict a member's relative rank or score.

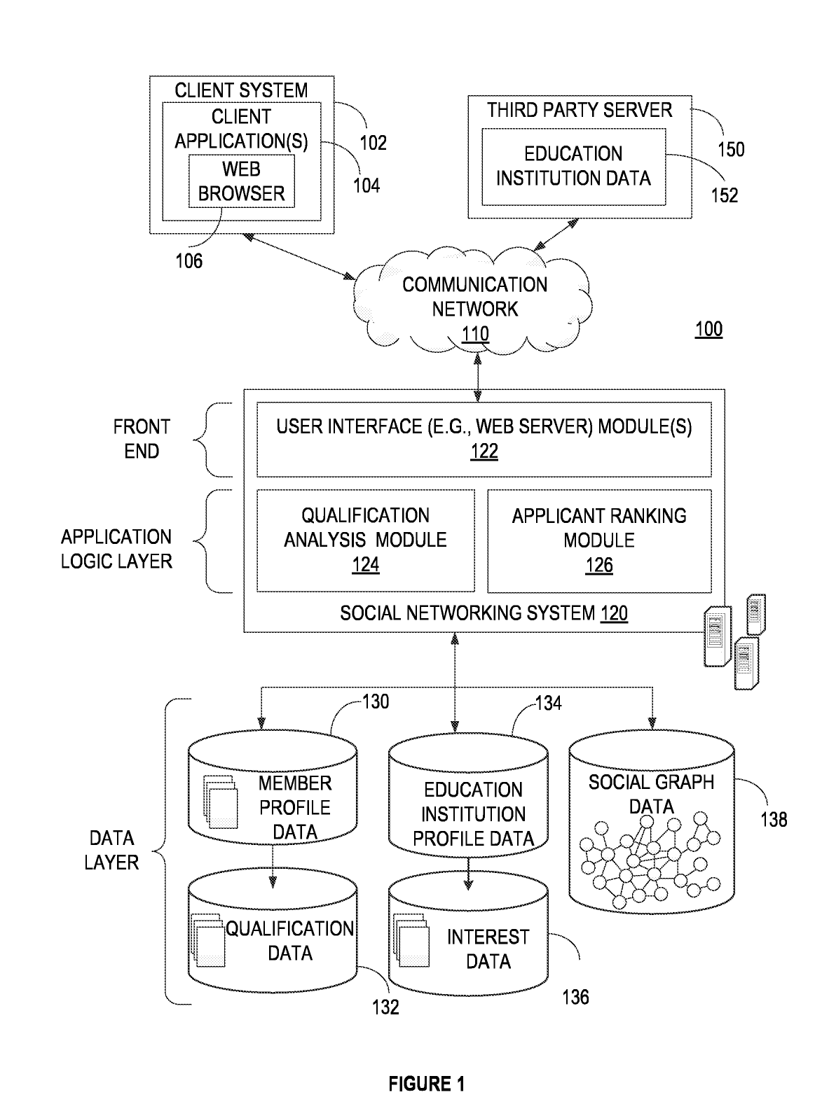

FIG. 1 is a network diagram depicting a client-social networking system environment 100 that includes various functional components of a social networking system 120, in accordance with some implementations. The client-social networking system environment 100 includes one or more client systems 102, a social networking system 120, and one or more other third party servers 150. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some implementations, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some implementations, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120. In some implementations, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some implementations, the client system 102 sends a request to the social networking system 120 for a webpage associated with the social networking system 120 (e.g., the client system 102 sends a request to the social networking system 120 for an updated web page associated with a particular university). For example, a member of the client system 102 logs onto the social networking system 120 and clicks to view educational information on a dedicated web page of the social networking system 120. In response, the client system 102 receives the requested data (e.g., information about schools and enrollment) and displays them on the client system 102.

In some implementations, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various implementations have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various implementations are by no means limited to this architecture.

As shown in FIG. 1, the front end consists of a user interface module(s) (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser applications or applications that have been developed for a specific platform to include any of a wide variety of mobile devices and operating systems.

As shown in FIG. 1, the data layer includes several databases, including databases for storing data for various members of the social networking system 120, including member profile data 130, qualification data 132 (e.g., data describing the qualifications of one or more members of the social networking system 120), education institution profile data 134, interest data 136 (e.g., data that describes which members are interested in attending which schools), and social graph data 138, which is stored in a particular type of database that uses graph structures with nodes, edges, and properties to represent and store data. Of course, with various alternative implementations, any number of other entities might be included in the social graph (e.g., companies, organizations, schools and universities, religious groups, non-profit organizations, and any other group), and as such, various other databases may be used to store data corresponding with other entities.

Consistent with some implementations, when a person initially registers to become a member of the social networking system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, memberships with third party servers 150, and so on. This information is stored, for example, in the member profile data 130. In some example embodiments, the social networking system 120 will also prompt the person to determine whether that person is interested in attending one or more schools in the future.

In some implementations, the member profile data 130 includes qualification data 132. In other implementations, the qualification data 132 is distinct from, but associated with, the member profile data 130. The qualification data 132 stores data for at least some of the members of the social networking system 120. Qualification data includes, but is not limited to, test scores, employment history, demographic information, work history, education history, grade point averages, hobbies, accomplishments, member ratings, recommendations, and so on.

The education institution profile data 134 also stores data related to schools represented on the social networking system 120 and their students. Thus, members of the social networking system 120 may be associated with schools. In addition, education institution profile data 134 includes information that describes the location of the school, the programs it offers, the demographic information of its students, the costs of school, scholarship programs offered by the school, important school dates (e.g., deadlines, terms beginning and ending dates, holidays, and so on), ranking information on the school, enrollment statistics, and other information.

In some example embodiments, the interest data 136 stores data received from a plurality of members that indicates the specific schools (or other educational opportunities) that a specific member is interested in pursuing. In some example embodiments, the interest data 136 for a respective member is received directly from the member. For example, a member selects one or more universities as potential educational opportunities that the member is interested in pursuing.

Once registered, a member may invite other members, or be invited by other members, to connect via the network service. A “connection” may include a bi-lateral agreement by the members, such that both members acknowledge the establishment of the connection. Similarly, with some implementations, a member may elect to “follow” another member. In contrast to establishing a “connection,” the concept of “following” another member typically is a unilateral operation and, at least with some implementations, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph data 138.

The social networking system 120 may provide a broad range of other applications and services that allow members the opportunity to share and receive information, often customized to the interests of the member. In some implementations, the social networking service may include a photo sharing application that allows members to upload and share photos with other members. As such, at least with some implementations, a photograph may be a property or entity included within a social graph. With some implementations, members of a social networking service may be able to self-organize into groups, or interest groups, organized around a subject matter or topic of interest. In some implementations, the data for a group may be stored in a database. When a member joins a group, his or her membership in the group will be reflected in the organization activity data, the member activity data, and the social graph data stored in the social graph data 138.

In some implementations, the application logic layer includes various application server modules, which, in conjunction with the user interface module(s) 122, generates various user interfaces (e.g., web pages) with data retrieved from various data sources in the data layer. With some implementations, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a qualification analysis module 124 or an applicant ranking module 126 may be separately implemented in their own application server modules.

In addition to the various application server modules, the application logic layer includes a qualification analysis module 124 and an applicant ranking module 126. As illustrated in FIG. 1, with some implementations, the qualification analysis module 124 and applicant ranking module 126 are implemented as services that operate in conjunction with various application server modules. For instance, any number of individual application server modules can invoke the functionality of the qualification analysis module 124 or the applicant ranking module 126 to determine a first potential applicant's standing in a group of potential applicants. However, with various alternative implementations, the qualification analysis module 124 or the applicant ranking module 126 may be implemented as their own application server module such that it operates as a standalone application. With some implementations, the qualification analysis module 124 or the applicant ranking module 126 include or have an associated publicly available API that enables third-party applications to invoke the functionality they provide.

Generally, the qualification analysis module 124 gathers, determines, and/or generates qualification data for a member of the server system (e.g., social networking system 120 in FIG. 1) and then analyzes that data. In some example embodiments, the qualification data is provided directly by the member. In this case the member will submit specific information about their qualifications, such as test scores or grade point averages.

The server system (e.g., social networking system 120 in FIG. 1) then stores the gathered data in the qualification data 132. In other example embodiments, the qualification data 132 is generated by the qualification analysis module 124 based on an analysis of the members user profile. For example, the qualification analysis module 124 can determine a member's years of work experience based on the work history data stored in member profile data 130. If the member's work history shows that the member started a job in 2012 as a web developer and has no updates since, the qualification analysis module 124 determines that the member has two years of experience in the web development field.

Once qualification data 132 has been gathered or generated, the qualification analysis module 124 sorts the qualification data 132 into distinct categories (e.g., GPA, GMAT score, or work history). Sorting qualification data 132 into categories allow members to be compared and ranked by the applicant ranking module 126.

The applicant ranking module 126 uses the qualification data 132 to generate ranks or scores for members relative to other members. In some example embodiments, the rankings are made for particular schools or educational opportunities. For example, the applicant ranking module 126 receives a request for applicant ranking data for school A in school year B. In response, the applicant ranking module 126 determines a list of members that have indicated interest in attending school A during school year B.

In some example embodiments, the applicant ranking module 126 uses the list of interested members for a particular school to generate relative ranks for each member in the list. The applicant ranking module 126 generates, for each category of qualification data 132, a score for each member. In some example embodiments, the scores are from 0 to 1 wherein 1 represents the highest score in the list of members and 0 represents the lowest. All other scores can then be scaled proportionally to fit within the score range. For example, if the category is LSAT scores a score of 180 is 1 and a score of 143 is 0, and all other scores are between these two points.

In some example embodiments, a category score for certain types of categories is generated based on reputation scores of one or more entities involved in the category score. For example, if the selected category is work experience, the category score is generated, at least in part, on the reputational score of the organizations that has employed the respective member. Thus, five years of work experience at an organization with a high reputation score will result in a higher category score than five years of work experience at an organization with a low reputations core. In some example embodiments, a reputation score for an organization or an education institution can be obtained by an outside ranking system or generated internally by an analysis of educational or career outcomes for members.

In some example embodiments, the applicant ranking module 126 generates a ranking for each member in each category based on the generated scores. In some example embodiments, the applicant ranking module 126 also generates an overall applicant ranking that combines the relative ranks of each category. In this case, the various categories can have different weights to emphasize more important categories and de-emphasize unimportant categories. The relative ranking can be customized for different schools or based on other variables.

In some example embodiments, the applicant ranking module 126 receives a request for the generated ranking information and transmits it to the requesting client system (e.g., client system 102 in FIG. 1).

In some example embodiments, the third party server 150 is a server system that is located remotely from the social networking system 120 and connects to the social networking system 120 via the communication network 110. In some example embodiments, the third party server 150 is associated with an education institution (e.g., a university) and stores educational institution data 152 that can be requested by the social networking system 120 to be stored as education institution profile data 134.

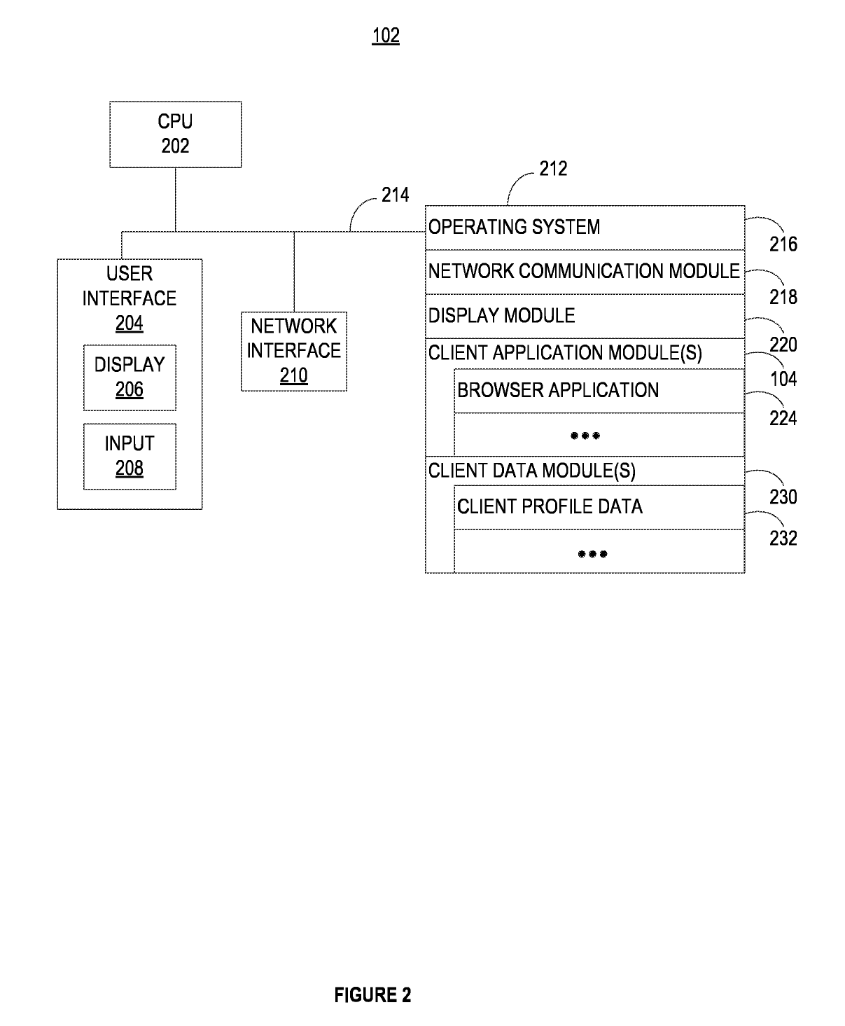

FIG. 2 is a block diagram illustrating a client system 102, in accordance with some implementations. The client system 102 typically includes one or more central processing units (CPUs) 202, one or more network interfaces 210, memory 212, and one or more communication buses 214 for interconnecting these components. The client system 102 includes a user interface 204. The user interface 204 includes a display 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some implementations, memory 212 or the computer-readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks, such as the Internet, other WANs, LANs, metropolitan area networks (MANs), etc.;
a display module 220 for enabling the information generated by the operating system 216 and client applications 104 to be presented visually on the display 206;
one or more client applications 104 for handling various aspects of interacting with the social networking system 120 (FIG. 1), including but not limited to:
   a browser application 224 for requesting information from the social networking system 120 (e.g., product pages and member information) and receiving responses from the social networking system 120; and
a client data module(s) 230, for storing data relevant to the clients, including but not limited to:
   client profile data 232 for storing profile data related to a member of the social networking system 120 associated with the client system 102.

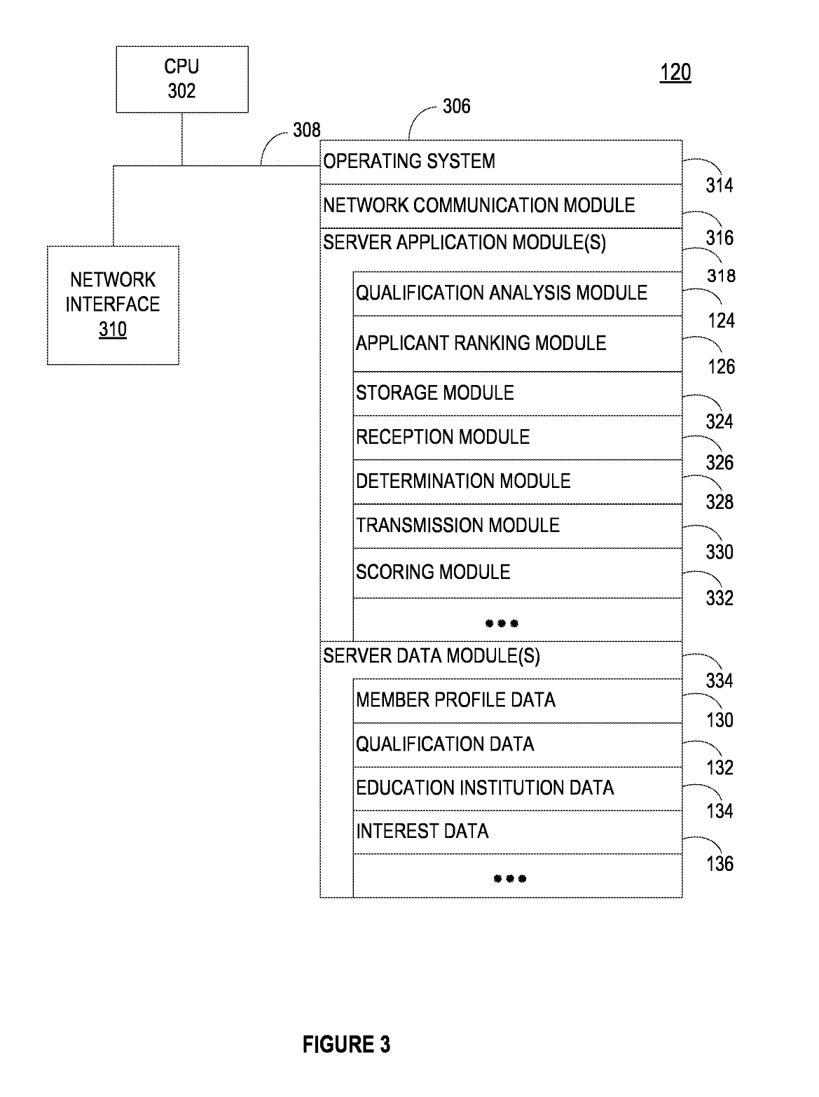

FIG. 3 is a block diagram further illustrating the social networking system 120, in accordance with some implementations. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some implementations, memory 306, or the computer readable storage medium of memory 306, stores the following programs, modules, and data structures, or a subset thereof:
an operating system 314 that includes procedures for handling various basic system services and for performing hardware dependent tasks;
a network communication module 316 that is used for connecting the social networking system 120 to other computers via the one or more communication network interfaces 310 (wired or wireless) and one or more communication networks, such as the Internet, other WANs, LANs, MANs, and so on;
one or more server application modules 318 for performing the services offered by social networking system 120, including but not limited to:
   a qualification analysis module 124 for analyzing qualification data (e.g., qualification data 132, FIG. 1) to determine one or more qualification categories, and for one or more members, determining the members' ranking in each of the qualification categories;
   an applicant ranking module 126 for ranking one or more members based on the categories scores generated by the qualification analysis module 124;
   a storage module 324 for storing qualification data 132 and interest data 136 for a plurality of members of the social networking system 120;
   a reception module 326 for receiving requests and data from one or more client systems (e.g., client system 102 in FIG. 1);
   a determination module 328 for determining all the members that have indicated interested in a specific education institution;
   a transmission module 330 for transmitting qualification data and rankings to a client system (e.g., client system 102 in FIG. 1); and
   a scoring module 332 for generating a category score for one or more members based on qualification data associated with the category; and
server data module(s) 334, holding data related to social networking system 120, including but not limited to:
   member profile data 130 including both data provided by the member person who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, and overall trend data for the social networking system 120, and so on;
   qualification data 132 including data that represents the various categories of data an education institution might use to determine whether or not to accept an applicant;
   education institution profile data 134 including data describing one or more education institutions (e.g., location, educational programs offer, applicants, alumni, reputation score, etc.), and
   interest data 136 including data that represents interest data received from members of the social networking system 120 and the education institutions those members are interested in attending.

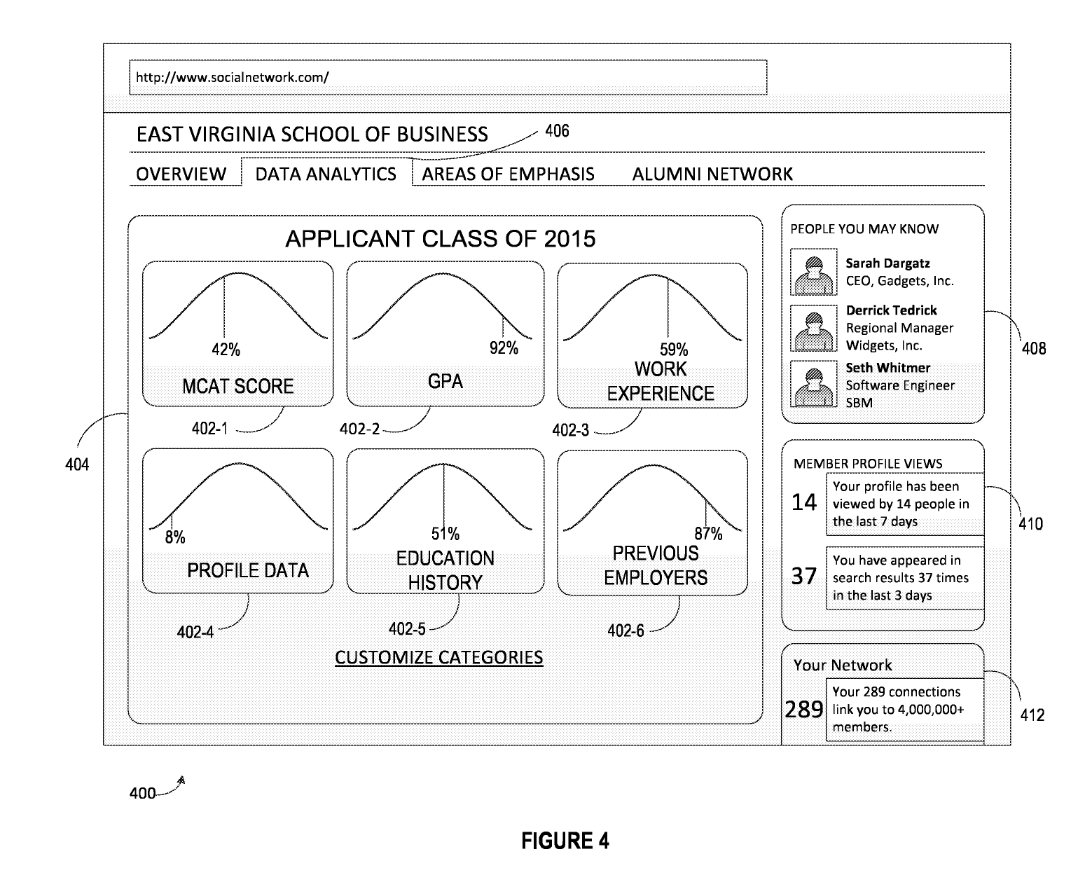

FIG. 4 is a member interface diagram illustrating an example of a user interface 400 or web page that incorporates data describing the position of a particular member in a potential applicant class for a particular education institution into a social networking service. The user interface 400 has information for a specific education institution (in this case the East Virginia School of Business) on an education institution profile web page produced by the social networking service. As can be seen, the data analytics tab 406 has been selected, the general overview profile page has been removed, and an applicant data analytics page 404 has been displayed. The applicant data analytics page 404 includes a plurality of graphs 402-1 to 402-6 depicting the relative position of a first member in the group of all members that are considered potential applicants for the respective education institution, wherein each graph section displays a normal curve (also known as a bell curve), a line visually indicating the first member's relative position in that particular category, the name of the category information that each graph represents, and a numerical representation of the member's position (e.g., a percentile rank). Members can then select particular graphs to get additional information about that category or choose to change the displayed category information to customized categories.

The user interface 400 also includes information in side sections of the interface 400 including a contact recommendation section 408, profile viewership statistic section 410, and a social graph statistic section 412.

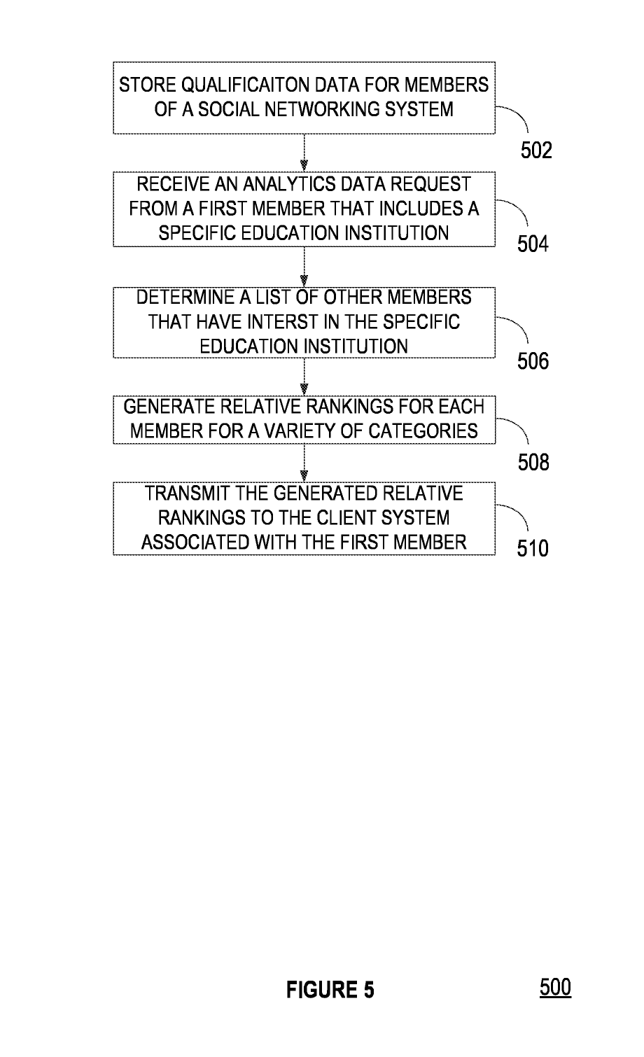

FIG. 5 is a flow diagram illustrating a method 500 for significantly improving marketing tools based on analysis of shopping cart abandonment patterns in accordance with some implementations. Each of the operations shown in FIG. 5 corresponds, in some embodiments, to instructions stored in a computer memory or computer readable storage medium. In some implementations, the method 500 described with reference to FIG. 5 is performed by a server system (e.g., social networking system 120 in FIG. 1).

In some example embodiments, the social networking system (e.g., social networking system 120 of FIG. 1) stores (502) qualification data (e.g., qualification data 132, FIG. 1) for members of a social networking system. Qualification data includes any data about a member that might influence an education institution's decision whether to admit a particular applicant. This information is stored in a database associated with the social networking system.

In some example embodiments, the social networking system then receives (504) a data analytics request from a first member (associated with a client system (e.g., client system 102 in FIG. 1)). A data analytics request is a request to conduct a data analysis for a specific education institution that is identified in the education institution.

In some example embodiments, the data analytics request is generated in response to a web page request for a web page associated with a specific education institution. In other example embodiments, the data analytics request is generated based on a specific selection of the user interface component (e.g., a button or link) that specifically results in sending a data analytics request. For example, in some embodiments, merely visiting the webpage associated with an education institution will cause a data analytics request to be generated and sent to the social networking system (e.g., social networking system 120 of FIG. 1). In another example, the data analytics request is only generated when a member selects (e.g., clicks) a data analytics link or button.

In some example embodiments, the social networking system (e.g., social networking system 120 of FIG. 1) determines (506) a list of other members of the social networking system that have an interest in the education institution specified in the data analytics request. In some example embodiments, the list is determined based on member interest data stored at the social networking system. Interest data is generated when a member indicates they have interest in attending a specific education institution during a specific time period (e.g., selecting a specific university and a potential school year).

The social networking system (e.g., social networking system 120 of FIG. 1) then generates (508) relative rankings for the first member and the list of other members who are potential applicants for the education institution specified by the data analytics request. The social networking system generates relative rankings by determining one or more categories of qualification data (e.g., categories that group similar data such as work experience, education experience, and/or skills). For each category, the social networking system generates a category score for each member, wherein a category score represents the degree to which the specific member's qualification data meets the ideal qualification. For example, if the category is work experience, the social networking system generates a score based on the number of years working in a relevant field, the quality of the employer, and the level of seniority reached. The score then is a number between 0 (which represents no work experience) and 1 (which represents more than 10 years at a top tier employer, with a high level of seniority reached).

Once the scores are generated, the social networking system (e.g., social networking system 120 of FIG. 1) ranks the members based on their generated category scores.

In some example embodiments, the social networking system (e.g., social networking system 120 of FIG. 1) then transmits the generated relative rankings to the client system associated with the first member. In some example embodiments, the relative rankings are transmitted to the client system (e.g., system 102 in FIG. 1) as a series of graphs, organized by category.

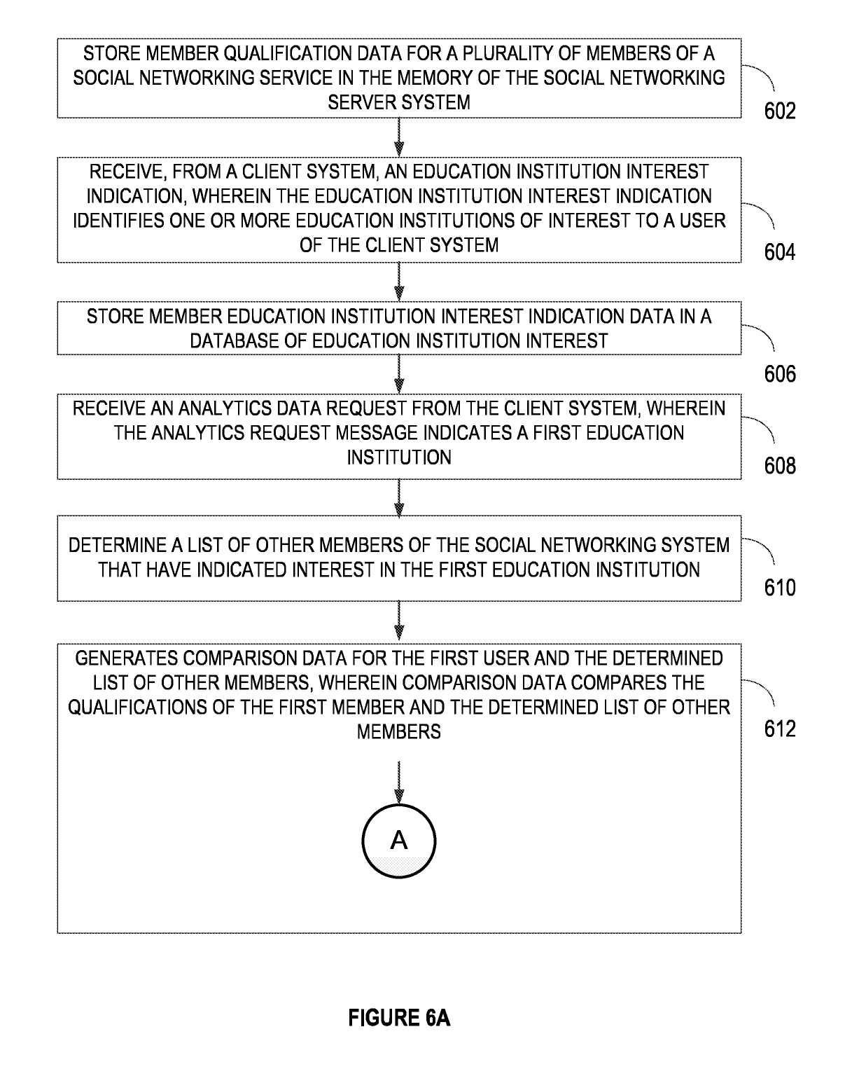

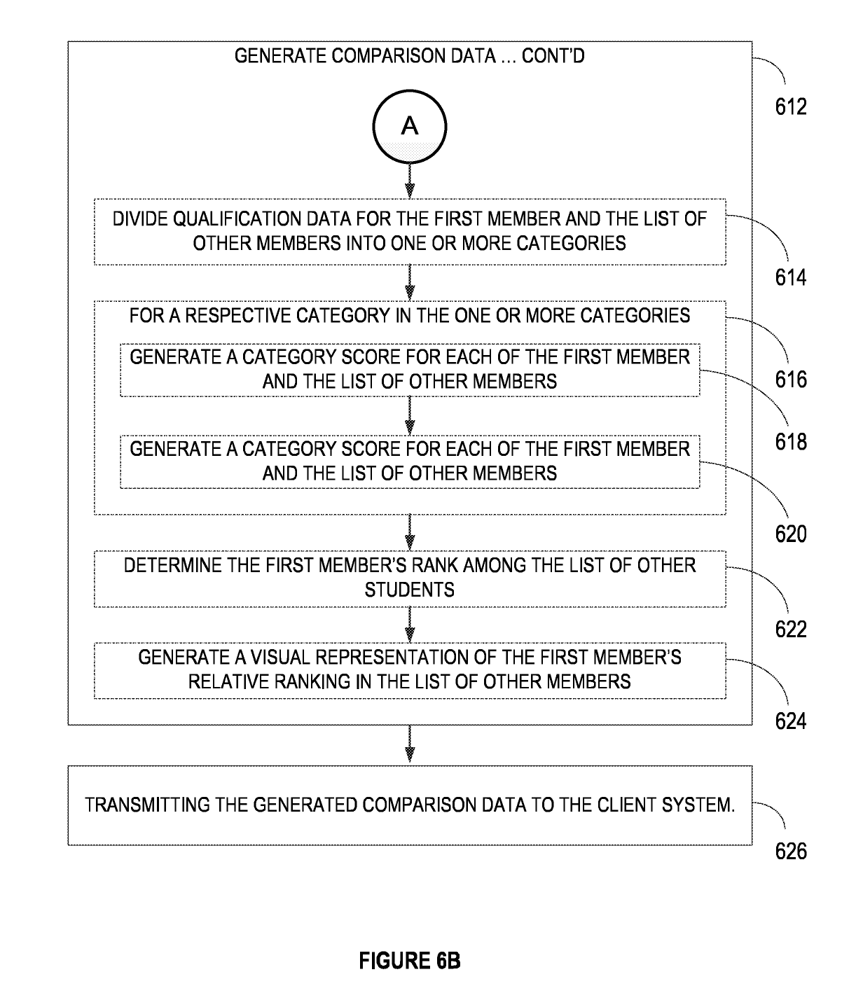

FIG. 6A is a flow diagram illustrating a method for using interest and qualification data from a large pool of members to generate useful statistical data for a particular member in accordance with some implementations. Each of the operations shown in FIG. 6A may correspond to instructions stored in a computer memory or computer readable storage medium. Optional operations are indicated by dashed lines (e.g., boxes with dashed-line borders). In some implementations, the method described in FIG. 6A is performed by the social networking system (e.g., social networking system 120 of FIG. 1). However, the method described can also be performed by any other suitable configuration of electronic hardware.

In some implementations the method is performed at a social networking system (e.g., social networking system 120 of FIG. 1) including one or more processors and memory storing one or more programs for execution by the one or more processors.

In some example embodiments, the social networking system (e.g., social networking system 120 of FIG. 1) stores (602) member qualification data for a plurality of members of a social networking service in the memory of the social networking server system. In some example embodiments, qualification data includes, but is not limited to, test scores, demographic data, education history, grades, charitable work, skills, and work history.

In some example embodiments, the social networking system (e.g., social networking system 120 of FIG. 1) receives (604), from a client system (e.g., client system 102 in FIG. 1), an education institution interest indication, wherein the education institution interest indication identifies one or more education institutions of interest to a user of the client system. In some example embodiments, the education institution interest indication identifies a particular time frame. For example, the education institution interest indication includes information identifying that Member A is interested in attending university B during the 2015 school year. Whenever, an education institution interest indication is received from a member, the list of members interested in education institutions is updated in real time. Thus, interest data for a particular education institution is constantly updated in real time in response to information received from members.

In some example embodiments, the education institution interest indication is stored in a database of education institution interest data. The database of education institution interest data includes interest information from a plurality of other members of the social networking system (e.g., social networking system 120 of FIG. 1).

In some example embodiments, the social networking system (e.g., social networking system 120 of FIG. 1) receives (608) an analytics data request from the client system, wherein the analytics request message indicates a first education institution. For example, the client system (e.g., system 102 in FIG. 1) sends a data analytics request message for a particular education institution.

In some example embodiments, the social networking system (e.g., social networking system 120 of FIG. 1) determines (610) a list of other members of the social networking system that have indicated interest in the first education institution. In some example embodiments, the list of other members of the social networking system that have indicated interest in the first education institution is determined based on interest data stored in an education institution interest database. As noted above, the list of other members of a social networking system that are interested in a first education institution is updated in real time based on information received from one or more members of the education institution. Thus, the list that is generated is updated in real time to give the most current version of members who are interested in a particular education institution.

In some example embodiments, the social networking system (e.g., social networking system 120 of FIG. 1) generates (610) comparison data for the first user and the determined list of other members, wherein comparison data compares the qualifications of the first member and the determined list of other members.

FIG. 6B is a flow diagram illustrating a method for using interest and qualification data from a large pool of members to generate useful statistical data for a particular member in accordance with some implementations. Each of the operations shown in FIG. 6B may correspond to instructions stored in a computer memory or computer readable storage medium. Optional operations are indicated by dashed lines (e.g., boxes with dashed-line borders). In some implementations, the method described in FIG. 6B is performed by the social networking system (e.g., social networking system 120 of FIG. 1). However, the method described can also be performed by any other suitable configuration of electronic hardware.

In some implementations the method is performed at a social networking system (e.g., social networking system 120 of FIG. 1) including one or more processors and memory storing one or more programs for execution by the one or more processors.

In some example embodiments, the social networking system (e.g., social networking system 120 of FIG. 1) divides (614) qualification data for the first member and the list of other members into one or more categories. In some example embodiments, the one or more categories are based on default categories stored at the social networking system (e.g., social networking system 120 of FIG. 1). In other example embodiments, the one or more categories are determined based on a custom request received from the client system (e.g., client system 102 in FIG. 1).

In some example embodiments, for a respective category in the one or more categories (616), the social networking system (e.g., social networking system 120 of FIG. 1) generates (618) a category score for each of the first member and the list of other members. The social networking system (e.g., social networking system 120 of FIG. 1) ranks (620) the first member and the list of other members relative to each other based on the generated category score.

In some example embodiments, the social networking system (e.g., social networking system 120 of FIG. 1) determines (622) the first member's rank among the list of other students. For example, the members are all ranked from highest score to lowest score in each category. The first member's rank can then be determined and reported to the first member. In some example embodiments, the reported rank lists the percentile that the first member falls into.

In some example embodiments, the social networking system (e.g., social networking system 120 of FIG. 1) generates (624) a visual representation of the first member's relative ranking in the list of other members. The social networking system transmits (626) the generated comparison data to the client system (e.g., system 102 in FIG. 1).

### Software Architecture

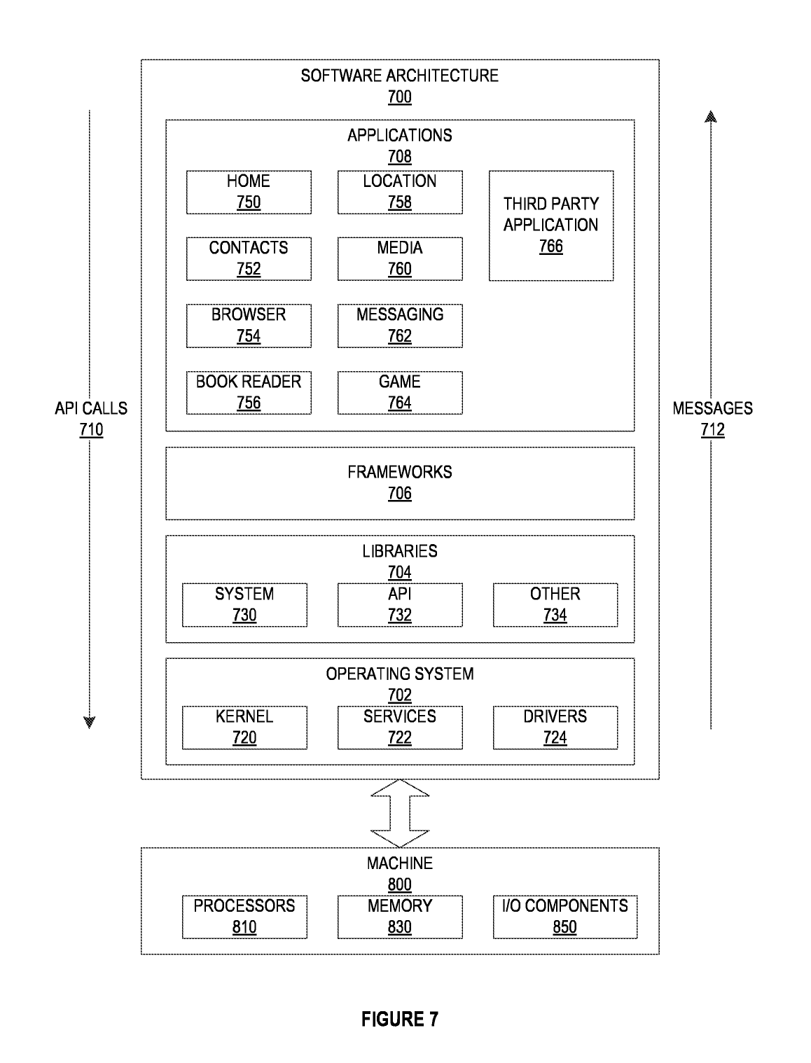

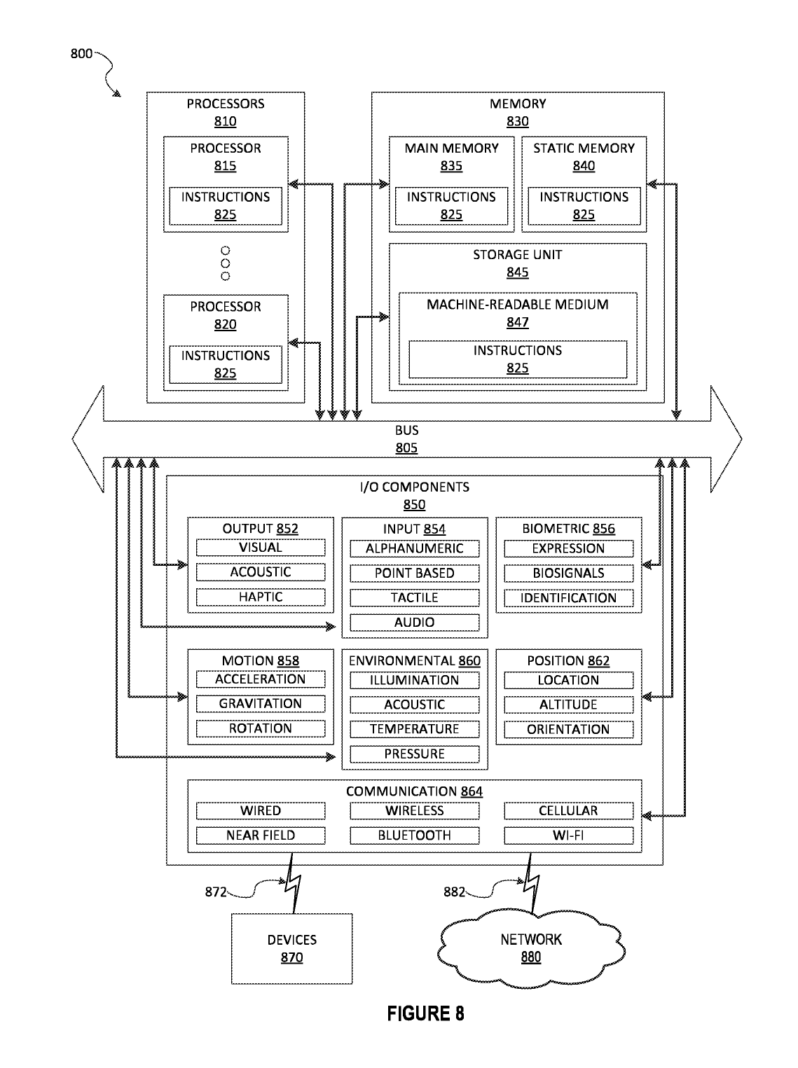

FIG. 7 is a block diagram illustrating an architecture of software 700, which may be installed on any one or more of devices of FIG. 1 (e.g., client system(s) 102). FIG. 7 is merely a non-limiting example of a software architecture and it will be appreciated that many other architectures may be implemented to facilitate the functionality described herein. The software 700 may be executing on hardware such as machine 800 of FIG. 8 that includes processors 810, memory 830, and I/O components 850. In the example architecture of FIG. 7, the software 700 may be conceptualized as a stack of layers where each layer may provide particular functionality. For example, the software 700 may include layers such as an operating system 702, libraries 704, frameworks 706, and applications 708. Operationally, the applications 708 may invoke application programming interface (API) calls 710 through the software stack and receive messages 712 in response to the API calls 710.

The operating system 702 may manage hardware resources and provide common services. The operating system 702 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling and/or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 704 may provide a low-level common infrastructure that may be utilized by the applications 708. The libraries 704 may include system libraries 730 (e.g., C standard library) that may provide functions such as memory allocation functions, string manipulation functions, mathematic functions, and the like. In addition, the libraries 704 may include API libraries 732 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 704 may also include a wide variety of other libraries 734 to provide many other APIs to the applications 708.

The frameworks 706 may provide a high-level common infrastructure that may be utilized by the applications 708. For example, the frameworks 706 may provide various graphic user interface (GUI) functions, high-level resource management, high-level location services, and so forth. The frameworks 706 may provide a broad spectrum of other APIs that may be utilized by the applications 708, some of which may be specific to a particular operating system or platform.

The applications 708 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 766 may invoke the API calls 710 provided by the mobile operating system 702 to facilitate functionality described herein.

### Example Machine Architecture and Machine-Readable Medium

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 825 (e.g., software, a program, an application, an applet, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 825, sequentially or otherwise, that specify actions to be taken by machine 800. Further, while only a single machine 800 is illustrated, the term “machine” shall also be taken to include a collection of machines 800 that individually or jointly execute the instructions 825 to perform any one or more of the methodologies discussed herein.

The machine 800 may include processors 810, memory 830, and I/O components 850, which may be configured to communicate with each other via a bus 805. In an example embodiment, the processors 810 (e.g., a CPU, a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 815 and processor 820 that may execute instructions 825. The term “processor” is intended to include a multi-core processor that may comprise two or more independent processors (also referred to as “cores”) that may execute instructions contemporaneously. Although FIG. 8 shows multiple processors 810, the machine 800 may include a single processor with a single core, a single processor with multiple cores (e.g., a multi-core process), multiple processors with a single core, multiple processors with multiples cores, or any combination thereof.

The memory 830 may include a main memory 835, a static memory 840, and a storage unit 845 accessible to the processors 810 via the bus 805. The storage unit 845 may include a machine-readable medium 847 on which are stored the instructions 825 embodying any one or more of the methodologies or functions described herein. The instructions 825 may also reside, completely or at least partially, within the main memory 835, within the static memory 840, within at least one of the processors 810 (e.g., within the processor's cache memory), or any suitable combination thereof, during execution thereof by the machine 800. Accordingly, the main memory 835, static memory 840, and the processors 810 may be considered as machine-readable media 847.

As used herein, the term “memory” refers to a machine-readable medium 847 able to store data temporarily or permanently and may be taken to include, but not be limited to, random-access memory (RAM), read-only memory (ROM), buffer memory, flash memory, and cache memory. While the machine-readable medium 847 is shown in an example embodiment to be a single medium, the term “machine-readable medium” should be taken to include a single medium or multiple media (e.g., a centralized or distributed database, or associated caches and servers) able to store instructions 825. The term “machine-readable medium” shall also be taken to include any medium, or combination of multiple media, that is capable of storing instructions (e.g., instructions 825) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

The I/O components 850 may include a wide variety of components to receive input, provide and/or produce output, transmit information, exchange information, capture measurements, and so on. It will be appreciated that the I/O components 850 may include many other components that are not shown in FIG. 8. In various example embodiments, the I/O components 850 may include output components 852 and/or input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 850 may include biometric components 856, motion components 858, environmental components 860, and/or position components 862 among a wide array of other components. For example, the biometric components 856 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, finger print identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 862 may include location sensor components (e.g., a GPS receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 and/or devices 870 via coupling 882 and coupling 872 respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine and/or any of a wide variety of peripheral devices (e.g., a peripheral device coupled via a USB).

Moreover, the communication components 864 may detect identifiers and/or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 864 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 880 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 825 may be transmitted or received over the network 880 using a transmission medium via a network interface device (e.g., a network interface component included in the communication components 864) and utilizing any one of a number of well-known transfer protocols (e.g., hypertext transfer protocol (HTTP)). Similarly, the instructions 825 may be transmitted and/or received using a transmission medium via the coupling 872 (e.g., a peer-to-peer coupling) to devices 870. The term “transmission medium” shall be taken to include any intangible medium that is capable of storing, encoding, or carrying instructions 825 for execution by the machine 800, and includes digital or analog communications signals or other intangible medium to facilitate communication of such software.

Furthermore, the machine-readable medium 847 is non-transitory (in other words, not having any transitory signals) in that it does not embody a propagating signal. However, labeling the machine-readable medium 847 as “non-transitory” should not be construed to mean that the medium is incapable of movement; the medium 847 should be considered as being transportable from one physical location to another. Additionally, since the machine-readable medium 847 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
storing member qualification data for a plurality of members of a social networking system in a memory of the social networking system;
receiving, from a client system, an education institution interest indication, wherein the education institution interest indication identifies one or more education institutions of interest to a first member of the client system;
receiving an analytics data request from the client system, wherein the analytics request indicates a first education institution;
determining a list of other members of the social networking system that have indicated interest in the first education institution;
generating comparison data for the first member and the determined list of other members, wherein comparison data compares member qualification data of the first member and the determined list of other members; and
transmitting the generated comparison data to the client system.

2. The method of claim 1, wherein the member qualification data includes test scores, demographic data, education history, grades, and work history.

3. The method of claim 1, wherein the education institution interest indication identifies a particular time frame.

4. The method of claim 1, further comprising storing member education institution interest indication data in a database of education institution interest.

5. The method of claim 4, wherein the database of education institution interest includes interest information from a plurality of other members of the social networking system.

6. The method of claim 1, wherein generating the comparison data further comprises:
dividing the qualification data for the first member and the list of other members into one or more categories.

7. The method of claim 6, further comprising:
for a respective category in the one or more categories:
generating a category score for each of the first member and the list of other members; and
ranking the first member and the list of other members relative to each other based on the generated category score.

8. The method of claim 7, further comprising:
determining the first member's rank among the list of other members.

9. The method of claim 8, further comprising generating a visual representation of the first member's relative ranking in the list of other members.

10. The method of claim 8, when the list of other members of the social networking system that have indicated interest in the first education institution is determined based on interest data stored in an education institution interest database.

11. The method of claim 6, wherein the one or more categories are based on default categories stored at the social networking system.

12. The method of claim 6, wherein the one or more categories are determined based on a custom request received from the client system.

13. A system comprising:
one or more processors;
memory; and
one or more programs stored in the memory, the one or more programs comprising instructions for:
storing member qualification data for a plurality of members of a social networking system in a memory of the social networking system;
receiving, from a client system, an education institution interest indication, wherein the education institution interest indication identifies one or more education institutions of interest to a first member of the client system;
receiving an analytics data request from the client system, wherein the analytics request indicates a first education institution;
determining a list of other members of the social networking system that have indicated interest in the first education institution;
generating comparison data for the first member and the determined list of other members, wherein comparison data compares member qualification data of the first member and the determined list of other members; and
transmitting the generated comparison data to the client system.

14. The system of claim 13, wherein the member qualification data includes test scores, demographic data, education history, grades, and work history.

15. The system of claim 13, wherein the education institution interest indication identifies a particular time frame.

16. The system of claim 13, further comprising instructions for storing member education institution interest indication data in a database of education institution interest.

17. A non-transitory computer readable storage medium storing one or more programs for execution by one or more processors, the one or more programs comprising instructions for:
storing member qualification data for a plurality of members of a social networking system in a memory of the social networking system;
receiving, from a client system, an education institution interest indication, wherein the education institution interest indication identifies one or more education institutions of interest to a first member of the client system;
receiving an analytics data request from the client system, wherein the analytics request indicates a first education institution;
determining a list of other members of the social networking system that have indicated interest in the first education institution;
generating comparison data for the first member and the determined list of other members, wherein comparison data compares member qualification data of the first member and the determined list of other members; and
transmitting the generated comparison data to the client system.

18. The non-transitory computer readable storage medium of claim 17, wherein the member qualification data includes test scores, demographic data, education history, grades, and work history.

19. The non-transitory computer readable storage medium of claim 17, wherein the education institution interest indication identifies a particular time frame.

20. The non-transitory computer readable storage medium of claim 17, further comprising instructions for storing member education institution interest indication data in a database of education institution interest.
